(19) United States
(12) Patent Application Publication
(10) Pub. No.: US 2008/0189930 A1
(43) Pub. Date: Aug. 14, 2008

(54) Method for making a hammer

(76) Inventor: Yung-Shou Chen, Taichung Hsien (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/705,838

(22) Filed: Feb. 13, 2007

(51) Int. Cl. B23P 13/00

(52) U.S. Cl. 29/557

(57) ABSTRACT

A method for making a hammer includes supplying a workpiece having a first end face and a second end face. The workpiece extends along an axis between the first and second end faces. The method further includes machining the workpiece such that the first and second end faces have substantially polygonal shape. The method also includes forming a hole through a central region of the workpiece.

### TECHNICAL FIELD

The present disclosure relates generally to a method for making hammers, and more particularly, to a method using a machining process to produce hammers.

### BACKGROUND

A sledgehammer is a tool that has a metal hammer head attached to a handle. One conventional method of making a sledgehammer includes a forging process, whereby the hammer head is shaped by plastic deformation. In particular, a workpiece is first cut from a round steel rod. The workpiece is then heated to a high temperature, e.g. 1100° C.±110° C., whereby the metal becomes malleable (typically red hot). The workpiece is next placed on an anvil and is shaped by hammering to a rough hammer shape. Once shaped the workpiece is then rapidly cooled by immersion in a cold liquid, and thus hardened. The workpiece may then be trimmed, for example, to remove any burrs. A hole may then be punched at a central region of the workpiece for receiving a handle of the sledgehammer.

The conventional forging process for making a hammer fails to produce hammers with high quality and precise size. Moreover, the conventional forging process consumes excessive energy.

The disclosed system is directed to overcoming one or more of the problems set forth above.

### SUMMARY OF THE INVENTION

In one aspect, the present disclosure is directed to a method for making a hammer. The method may include supplying a workpiece having a first end face and a second end face. The workpiece may extend along an axis between the first and second end faces. The method may further include machining the workpiece such that the first and second end faces have a substantially polygonal shape. The method may also include forming a hole through a central region of the workpiece.

In another aspect, the method for making a hammer may include supplying a workpiece having a first end face and a second end face. The workpiece may extend along an axis between the first and second end faces. The method may further include lathing corners of the workpiece such that the first and second end faces have a substantially polygonal shape. The method may also include machining outer edges of the first and second end faces of the workpiece to form a substantially beveled outer contour of the first and second end faces. The method may further include forming a hole through a central region of the workpiece.

### BRIEF DESCRIPTION OF THE DRAWINGS

FIG. 1 is a perspective view of a hammer head made according to one embodiment of this disclosure;

FIGS. 2A, 2B, 3A, 3B, 4A, 4B, 5A, 5B, 6A-6C, 7A-7D, 8A-8C, 9A-9C, 10A-10C, and 11A-11C schematically illustrate perspective views of a hammer in accordance with the present disclosure at various stages of fabrication; and

FIG. 12 is a flow chart illustrating an exemplary method of using a machining process to produce a hammer head consistent with an additional aspect of the present disclosure.

### DETAILED DESCRIPTION

The present disclosure is directed to a method of making a hammer, for example, a sledgehammer by machining. In one exemplary embodiment, a metal hammer head may be formed by machining a metal part. During the machining process, material is removed from the workpiece by drilling, sawing, milling, turning, or grinding.

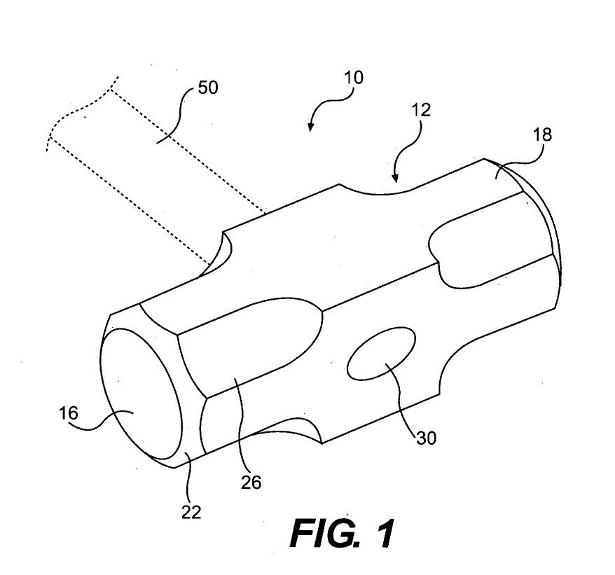

FIG. 1 shows a perspective view of an exemplary metal sledgehammer head 10 made according to a process consistent with the present disclosure. Sledgehammer head 10 may include a body 12, extending between a first end face 16 and a second end face 18. Each of first and second end faces 16 and 18 may include a beveled outer contour 22 at a peripheral edge of first and second end faces 16 and 18. Sledgehammer head 10 may further include a beveled surface 26 at each corner of body 12. A handle hole 30 may be formed in a central region of body 12. A handle 50 of the sledgehammer may be inserted into hole 30.

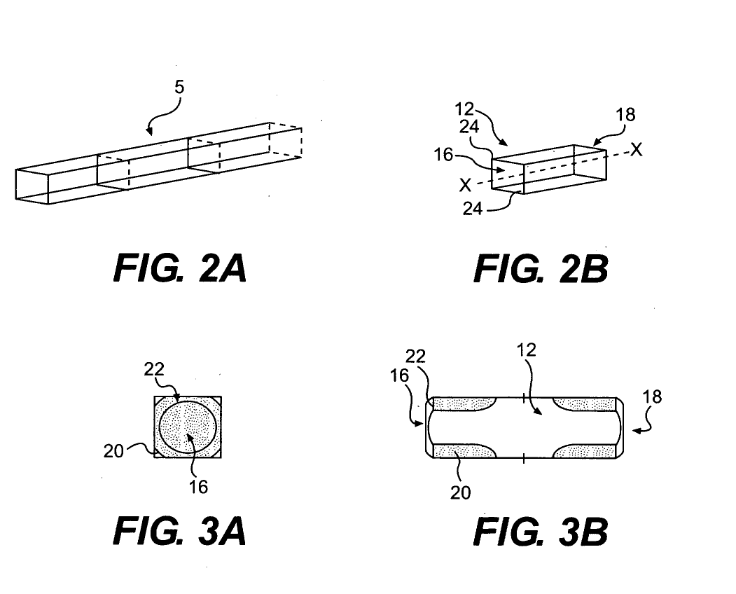

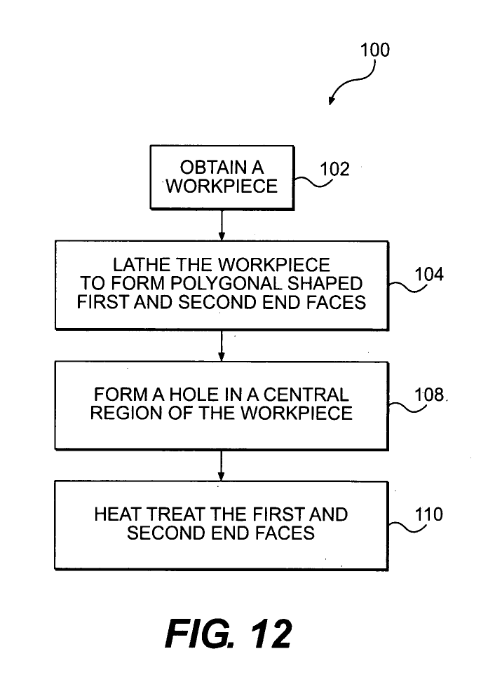

A process for manufacturing the sledgehammer head 10 shown in FIG. 1 will next be described with reference to FIGS. 2A-11C and the flow chart shown in FIG. 12. FIG. 2A shows an elongated steel bar 5, which may be used as the starting material for making sledgehammer head 10. For example, the material of the steel bar 5 may be square steel with grade number 10450 to 10650 made by CHINA STEEL™. In FIG. 2B, raw material (workpiece), which is also denoted by reference number 12, and from which body 12 of sledgehammer head 10 is to be made, is obtained typically by cutting elongated steel bar 5. One skilled in the art will readily recognize that workpiece 12 may be made of any steel or other conventional material suitable for making a hammer head. Workpiece 12 may be cut by using different techniques, such as sawing, chiseling, shearing, or burning by laser. In addition, workpiece 12 may be cut with a gas jet, plasma, water jet or electric discharge, etc. In one exemplary embodiment, steel bar 5 may have a square cross-section, and, once cut, workpiece 12 may retain such square cross-section extending along a central axis X between a first end face 16 and a second end face 18.

In the next step, as shown in FIGS. 3A and 3B, which show side and front views, respectively, of workpiece 12, corners 24 of workpiece 12 may be removed with a metalworking lathe. A substantially round surface 20 may be formed after the square corners are removed. In one exemplary embodiment, lathing equipment FastCut™ FC-1540, commercially available from Chien Yih Machinery Co., Ltd, may be used to perform such lathing. However, it is contemplated that other conventional lathing equipment may also be used.

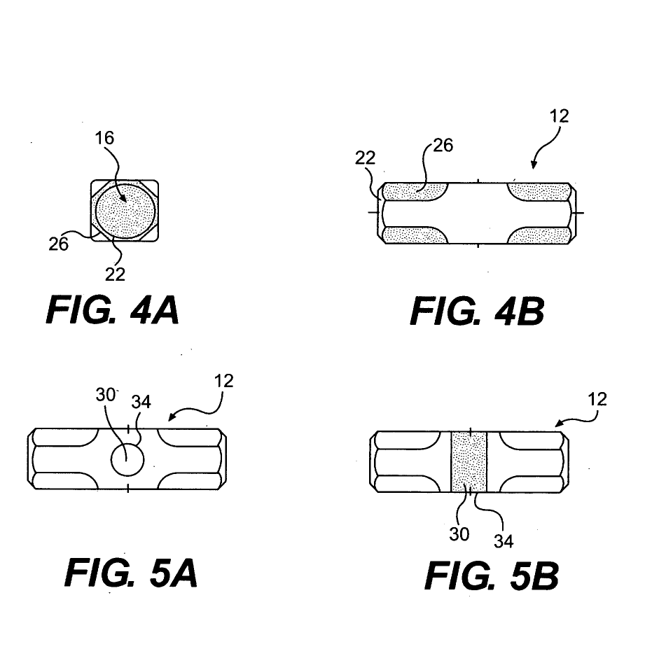

FIG. 4A shows a side view and FIG. 4B shows a front view of the workpiece 12 at a later stage in the process consistent with the present disclosure. As shown in FIGS. 4A and 4B, round surface 20 of workpiece 12 may be further machined, for example, precisely lathed, to form a substantially beveled surface 26 at each corner of workpiece 12. In one exemplary lathing process, workpiece 12 may be machined by a conventional polygon lathe, which can provide high concentricity, symmetricity, and accuracy on the cutting location and size. After such precise lathing, first and second end faces 16 and 18 of workpiece 12 may have a substantially polygonal shape, which is substantially octagonal, for example.

As further shown in FIGS. 4A and 4B, edges of outer contour 22 of the first and second end faces 16 and 18 of workpiece 12 may be removed such that outer contour 22 may be substantially beveled. The beveling may be achieved with a chamfering process, in which metalworking lathe discussed above removes the edges of workpiece 12. Alternatively, the edges of outer contour 22 may be removed using a known chamfer cutter or a chamfer plane.

FIG. 5A shows a top view and FIG. 5B shows a front view of workpiece 12, in which handle hole 30 is next formed in a central region 34 of workpiece 12. Handle hole 30 may be formed by drilling or milling through central region 34 of workpiece 12, and may have a circular shape, elliptical shape, or any other suitable shape to accommodate a handle. In one exemplary embodiment, after hole 30 is drilled through the workpiece 12, hole 30 may be further machined, for example, by milling, so that hole 30 may have an elliptical shape. Hole 30 may be milled with a manually controlled milling machine or software controlled milling machine.

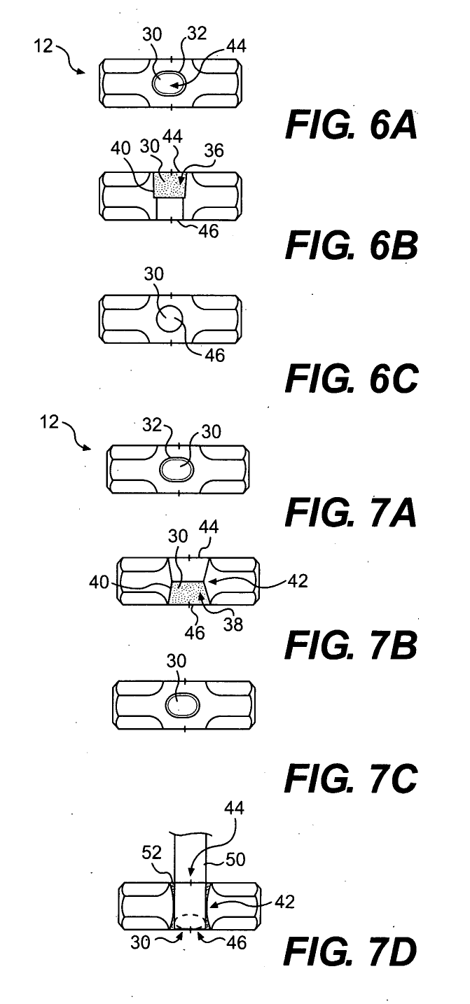

FIG. 6A shows a top view, FIG. 6B shows a front view, and FIB. 6C shows a bottom view of workpiece 12 after a further step of the process consistent with the present disclosure. As shown in FIGS. 6A, 6B, and 6C, an additional milling process may first be performed on an upper portion 36 of hole 30. FIG. 7A shows a top view, FIG. 7B shows a front view, and FIG. 7C shows a bottom view of the workpiece 12 after a further milling process step. As shown in FIGS. 7A, 7B, and 7C, the further milling process step may be performed on a lower portion 38 of hole 30. Although hole 30 may also be punched, the milling process can provide higher concentricity, symmetricity, and accuracy on the location and size of the hole than punching.

As shown in FIGS. 6A-6C and 7A-7C, in one exemplary embodiment, inner walls 40 of hole 30 may be formed with a conical or tapering shape, as a result of the milling steps shown in these figures. Hole 30 may have a middle part 42, a first opening 44 and a second opening 46, such that the inner diameter of hole 30 increases from middle part 42 to first and second openings 44 and 46. As shown in FIGS. 6A and 6C, openings 44 and 46 are opposite one another. In one exemplary embodiment, inner walls 40 of hole 30 are tapered by about 3 degrees. Hole 30 may have its first and second openings 44 and 46 chamfered to form a substantially annular beveled region 32, shown in FIGS. 6B, 7B, and 7D, at first and second openings 44 and 46, so that handle 50 of the sledgehammer can be easily inserted into hole 30.

As shown in FIG. 7D, the diameters of first and second openings 44 and 46 of hole 30 are larger than the diameter of middle part 42 of hole 30, so that a handle 50 of the sledgehammer can fit snugly into hole 30. In order to further secure handle 50 in the handle hole 30, glue 52 can be filled into hole 30. Since the filled glue has elasticity, when the sledgehammer is used, glue 52 can help absorb shock.

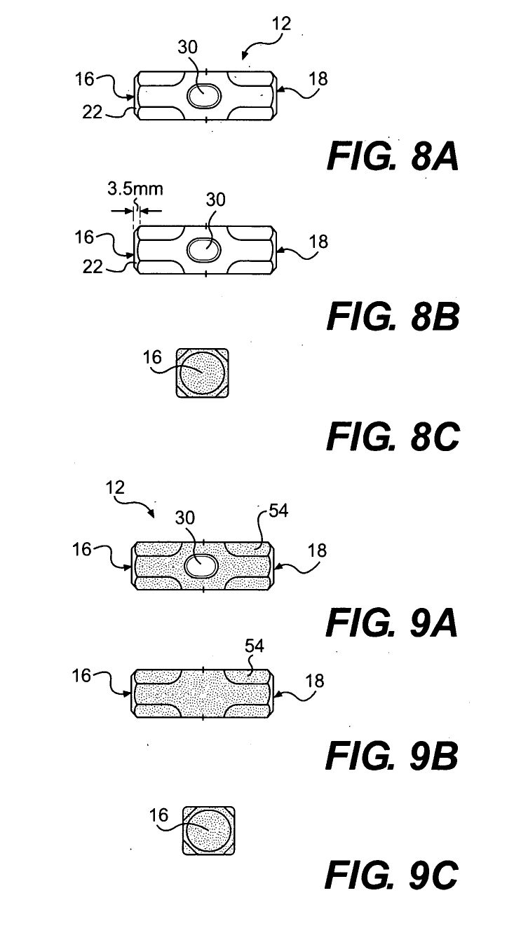

FIG. 8A shows a top view, FIG. 8B shows a front view, and FIG. 8C shows a side view of the workpiece 12 after further processing. As shown in FIGS. 8A, 8B, and 8C, beveled outer contour 22 may be further chamfered to have a thickness of about 3.5 millimeters. A wide variety of techniques including heat or mechanical processes may be used to improve the hardness of first and second end faces 16 and 18. In one exemplary embodiment, first and second end faces 16 and 18 are hardened by heat treatment, which may include induction hardening. During induction hardening, end faces 16 and 18 are heated by electromagnetic induction, for example. Induction hardening may be advantageous because it can selectively harden end faces 16 and 18 without affecting the properties of workpiece 12 as a whole. End faces 16 and 18 may then be quenched, during which a martensitic transformation occurs, which increases the hardness and brittleness of end faces 16 and 18. End faces 16 and 18 may then be tempered at a temperature within a range of 400° C.-600° C. The tempering process may further strengthen end faces 16 and 18.

FIG. 9A shows a top view, FIG. 9B shows a front view, and FIG. 9C shows a side view of workpiece 12 after additional processing. Whole surface 54 of workpiece 12 may be finished with sandblasting as shown in FIGS. 9A, 9B and 9C. In the sandblasting process, solid particles, for example, sand, steel grit, or glass beads, may be forced onto the surface of the workpiece 12 at high speed and high pressure in a controllable manner. Typically workpiece 12 is rotationally sandblasting, so that surface 54 of workpiece 12 may be cleaned and roughened and ready to be painted. The dots shown in FIGS. 9A-9C indicate a sandblasted surface after the sandblasting processing.

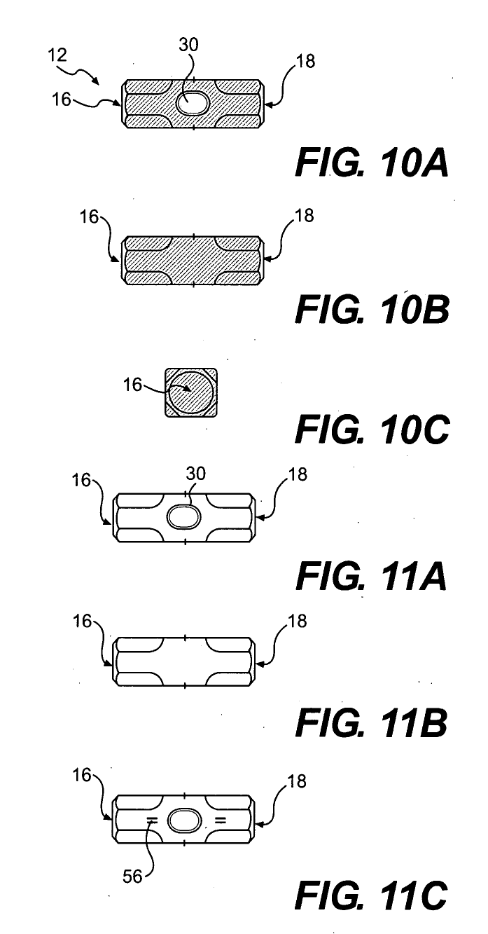

FIG. 10A shows a top view, FIG. 10B shows a front view, and FIG. 10C shows a side view of workpiece 12 after further processing. As shown in FIGS. 10A, 10B and 10C, after sandblasting process, workpiece 12 may be painted evenly, for example, with black paint. End faces 16 and 18 of workpiece 12 may then be polished, and then treated with antirust oil or lacquer. The shading as shown in FIGS. 10A-10C indicates black paint painted on workpiece 12 according to one exemplary embodiment of the present disclosure.

FIG. 11A shows a top view, FIG. 11B shows a front view, and FIG. 11C shows a bottom view of workpiece 12. As shown in FIGS. 11A-11C, workpiece 12 may be polished and then stamped with markings 56. The markings 56 may include, for example, serial number, size, manufacturer, warnings, or other information that a manufacturer or a customer may consider useful. Completed workpiece 12 may be used as a hammer head for a sledgehammer, for example.

FIG. 12 shows a flow chart 100 illustrating an exemplary method using the disclosed process to produce hammers according to an exemplary disclosed embodiment. In step 102, workpiece 12 may be cut from steel bar 5, as shown in FIGS. 2A and 2B. In step 104, workpiece 12 may be machined such that the first and second end faces 16 and 18 may have substantially polygonal shape. In one exemplary embodiment, lathing equipment FastCut™ FC-1540, commercially available from Chien Yih Machinery Co., Ltd, may be used to perform such lathing, whereby corners 24 of workpiece 12 may be removed with a metal working lathe to form a substantially round corner surface 20 at end faces 16 and 18. As noted above, round corner surface 20 may be further lathed such that end faces 16 and 18 may have substantially polygonal shape, for example, a substantially octagonal shape. As further noted above, for the steps of lathing, a lathing equipment may be used. In one exemplary embodiment, lathing equipment FastCut™ FC-1540, which is commercially available from Chien Yih Machinery Co., Ltd, may be used.

In step 108, hole 30 may be formed through central region 34 of workpiece 12 by milling, (FIGS. 5A and 5B). As shown in FIGS. 6A, 6B and 6C, the milling process may first be performed on upper portion 36 of hole 30. As shown in FIGS. 7A, 7B and 7C, the milling process may then be performed on lower portion 38 of hole 30. Hole 30 may be milled such that hole 30 may have an elliptical cross-section, and may have tapered inner walls 40. First and second openings 44 and 46 of hole 30 may be machined to form substantially annular beveled region 32 at first and second openings 44 and 46. In step 110, as shown in FIGS. 8A-8C, first and second end faces 16 and 18 may be heated inductively, then quenched, and then tempered.

The manufacturing process for making sledgehammers consistent with the present disclosure provides several advantages over the conventional forging processes. For example, because a machining process is used to produce the hammer head, the end faces of the hammer head can be cut to more precise dimensional tolerances than those achieved with conventional forging process. The disclosed method thus permits high manufacturing volume of hammer heads having higher quality. Furthermore, because the disclosed method uses a heating treatment that tempers the end faces of the workpiece at a temperature within a range of 400° C.-600° C., which is much lower than the heating treatment used in the conventional forging process, which heats the workpiece to 1100° C.±100° C., less energy is expended in the process consistent with the present disclosure. As a result, manufacturing costs may be reduced.

It will be apparent to those skilled in the art that various modifications and variations can be made to the manufacturing process for making sledgehammers. Other embodiments will be apparent to those skilled in the art from consideration of the specification and practice of the disclosed manufacturing process for making sledgehammers. It is intended that the specification and examples be considered as exemplary only, with a true scope being indicated by the following claims and their equivalents.

What is claimed is:

1. A method for making a hammer comprising:
supplying a workpiece, having a first end face and a second end face, the workpiece extending along an axis between the first and second end faces;
machining the workpiece such that the first and second end faces have a substantially polygonal shape; and
forming a hole through a central region of the workpiece.

2. The method of claim 1, wherein the supplying includes cutting a piece of metal from an elongated metal bar.

3. The method of claim 1, wherein the supplying includes supplying a workpiece having a substantially square cross-section.

4. The method of claim 1, wherein the substantially polygonal shape is a substantially octagonal shape.

5. The method of claim 4, wherein machining the workpiece includes removing corners of the workpiece to form the substantially polygonal shape at the first and second end faces of the workpiece.

6. The method of claim 1, further comprising removing outer edges of the first and second end faces of the workpiece to form a substantially beveled outer contour of the first and second end faces.

7. The method of claim 1, wherein the machining includes lathing the workpiece to form a substantially round shape of the first and second end faces of the workpiece, and further lathing the substantially round shape to form the substantially polygonal shape of the first and second end faces of the workpiece.

8. The method of claim 1, wherein the forming the hole includes drilling through the central region of the workpiece.

9. The method of claim 8, further comprising:
milling the hole such that the hole has an elliptical shape; and
milling an inner wall of the hole such that the inner wall is tapered.

10. The method of claim 8, wherein the hole has a first opening and a second opening, the method further comprising:
machining an inner contour of the first and second openings of the hole to form a substantially annular beveled region at the first and second openings.

11. The method of claim 1, further comprising hardening the first and second end faces by heat treatment.

12. The method of claim 11, wherein the heat treatment includes:
heating the first and second end faces inductively;
quenching the first and second end faces; and
tempering the first and second end faces.

13. A method for making a hammer comprising:
supplying a workpiece having a first end face and a second end face, the workpiece extending along an axis between the first and second end faces;
lathing corners of the workpiece such that the first and second end faces have substantially polygonal shape;
machining outer edges of the first and second end faces of the workpiece to form a substantially beveled outer contour of the first and second end faces; and
forming a hole through a central region of the workpiece.

14. The method of claim 13, wherein the lathing includes lathing the workpiece to form a substantially round shape of the first and second end faces of the workpiece, and further lathing the substantially round shape to form the substantially polygonal shape of the first and second end faces of the workpiece.

15. The method of claim 13, wherein machining the workpiece to form a substantially polygonal shape includes lathing the workpiece to form a substantially octagonal shape at the first and second end faces of the workpiece.

16. The method of claim 13, wherein machining outer edges includes lathing the outer contour of the first and second end faces to form a substantially annular beveled region at the first and second end faces.

17. The method of claim 13, further comprising hardening the first and second end faces by heat treatment of the first and second end faces.

18. The method of claim 17, wherein the heat treatment includes:
heating the first and second end faces inductively;
quenching the first and second end faces; and
tempering the first and second end faces.

19. The method of claim 13, further comprising:
milling the hole such that the hole has an elliptical shape; and
machining an inner wall of the hole such that the hold has a tapered wall.

20. The method of claim 13, wherein the hole has first and second openings, the method further comprising:
machining an inner contour of the first and second openings of the hole to form a substantially annular beveled region at the first and second openings.
